(19) United States
(12) Patent Application Publication
(10) Pub. No.: US 2007/0158613 A1
(43) Pub. Date: Jul. 12, 2007

(54) Liquid crystal composition

(76) Inventor: Xin-Hua Chen, Erie, CO (US)

Correspondence Address: GREENLEE WINNER AND SULLIVAN P C, 4875 PEARL EAST CIRCLE, SUITE 200, BOULDER, CO, 80301, US

(21) Appl. No.: 11/327,593

(22) Filed: Jan. 6, 2006

(51) Int. Cl. C09K 19/30; C09K 19/12

(52) U.S. Cl. 252/299.63; 252/299.01; 252/299.66

(57) ABSTRACT

A liquid crystal composition having a high voltage holding ratio and low viscosity is provided. More particularly, provided is a liquid crystal composition comprising: 10-90% by weight of one or more compounds of Type I having formula: 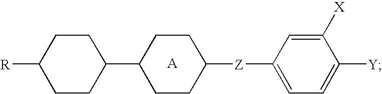
1-40% by weight of one or more compounds of Type II having formula: 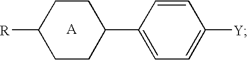
1-50% by weight of one or more compounds of Type III having formula: 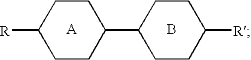
and 0-40% by weight of one or more compounds of Type IV having formula: 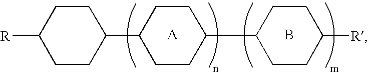
wherein in the formulas, 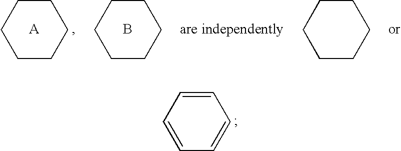
Z is a direct bond or ethylene; n=1,2; m=0,1 and n+m >1; R and R′ are optionally substituted alkyl groups with from 1-7 carbons in the chain, where the alkyl groups may be straight chain or branched, and the optional substituents are one or more hydrogens can be replaced with one or more F or D atoms, and one or more carbon atoms can be replaced with —O—; and X, Y are selected from the group consisting of: F, H, Cl and trifluoro methyl (—CF₃) groups.

### BACKGROUND OF THE INVENTION

Liquid crystal displays (LCD) currently dominate the flat panel display market. As the use of liquid crystals in display elements has increased, the demand for improved performance has also increased. High quality and reliable image display is required for liquid crystal displays, which in turn requires the liquid crystal mixture used have specific material properties such as high voltage holding ratio and low viscosity. There is a need for liquid crystal mixtures that have desirable material properties.

### BRIEF SUMMARY OF THE INVENTION

The present invention relates to a liquid crystal composition having a high voltage holding ratio and low viscosity. More particularly, provided is a liquid crystal composition comprising: 10-90% by weight of one or more compounds of Type I; 1-40% by weight of one or more compounds of Type II; 1-50% by weight of one or more compounds of Type III; and 0-40% by weight of one or more compounds of Type IV. In the percentages of compounds listed, all subranges and all individual values therein are intended to be included to the same extent as if they were explicitly listed in this disclosure.

In certain embodiments, the composition comprises between 1-5%; between 5-10%; between 10-15%; between 15-20%; between 20-25%; between 25-30%; between 30-35%; between 35-40%; below 40%; and all other subranges and all individual values therein by weight of one or more compounds of Type I, along with sufficient amounts of other compounds as described herein to bring the total to 100%. In certain embodiments, the composition comprises between 1-4%; 5-35%; between 10-30%; between 15-25% and all other subranges and all individual values therein by weight of one or more compounds of Type II, along with sufficient amounts of other compounds as described herein to bring the total to 100%. In certain embodiments, the composition comprises between 5-15%; between 15-25%; between 25-35%; between 35-45%; between 5-45%; between 10-40%; between 15-35%; between 20-30% and all other subranges and all individual values therein by weight of one or more compounds of Type III, along with sufficient amounts of other compounds as described herein to bring the total to 100%. In certain embodiments, the composition comprises between 1-5%; between 5-15%; between 15-25%; between 25-35%; between 35-40%; between 1-35%; between 5-30%; between 10-25% and all other subranges and all individual values therein by weight of one or more compounds of Type IV, along with sufficient amounts of other compounds as described herein to bring the total to 100%.

The formulas for Type I-IV are given below:

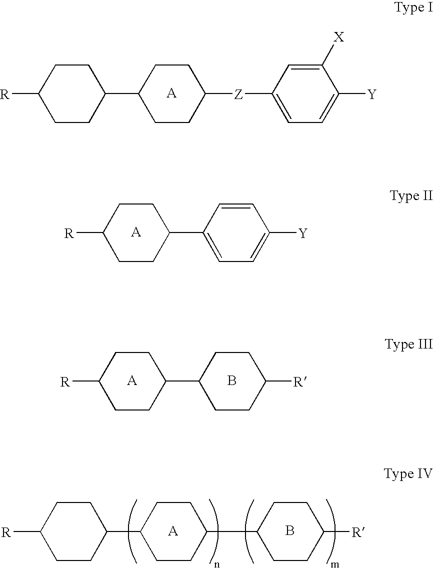

In all formulas, 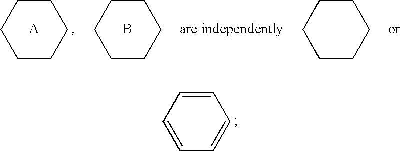
Z is a direct bond (no additional carbon atoms) or ethylene; n=1,2; m=0,1 and n+m >1; R and R′ are optionally substituted alkyl groups with from 1-7 carbons in the chain, where the alkyl groups may be straight chain or branched, and the optional substituents are one or more hydrogens can be replaced with one or more F or D atoms, and one or more carbon atoms can be replaced with —O—, X, Y are selected from the group consisting of: F, H, Cl and trifluoro methyl (—CF₃) groups. In the formulas, where more than one group is repeated, the repeated group may be the same or different. For example, in the group 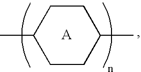
each ring is independently 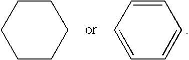
In one embodiment, in the compounds of Type II, compounds having Y=trifluoromethyl are not included.

In one embodiment, when a compound of Type II having Y=F, R=unsubstituted alkyl group having from 1-7 carbons in the chain or alkoxymethyl group with from 2-7 carbons atoms in the chain is present in the composition, any compounds of Type I having 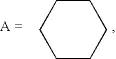
X and Y=F and Z=ethylene are present in the composition below 15% by weight or more than 80% by weight. In one embodiment, when a compound of Type I having X=Y=F; 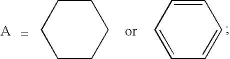
Z is a direct bond and R is an unsubstituted alkyl group with from 1-7 carbons in the chain is present in the composition, any compounds of formula (a): 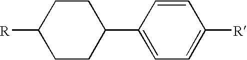
where R′ is F, or CF₃ or an unsubstituted alkyl group with from 1-7 carbons in the chain and R is an unsubstituted alkyl group with from 1-7 carbons in the chain, or compounds of formula (b): 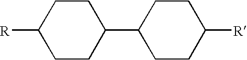
where R is R″OCH₂, where R″ is an unsubstituted alkyl group with from 1-5 carbons in the chain and R′ is an unsubstituted alkyl group with from 1-7 carbons in the chain are collectively present in the composition in an amount less than 5% by weight.

A further aspect of the invention is the preparation of compositions having desired physical properties. For example, compositions containing a higher percentage of Type I compounds have higher dielectric constant and higher N/I transition. Compositions containing a higher percentage of Type II and III compounds have lower viscosity. Compositions containing a higher percentage of Type IV compounds have broader N/I transition and higher birefringence.

The percentages of particular components in mixtures described herein are determined by weight.

### DETAILED DESCRIPTION OF THE INVENTION

The following description provides non-limiting examples which may be useful in further understanding the invention.

### Compound Examples

The following non-limiting examples of compounds can be used in the compositions of the invention. In the abbreviation of the compounds, n and m correspond to the carbon number in the R groups, starting with the R group and continuing to the R′ group, if present. For example, “1” indicates a methyl group. As one example, the compound: 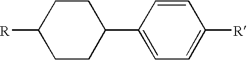
is abbreviated CPnm, wherein n is the number of carbon atoms in the R group and m is the number of carbon atoms in the R′ group. The compound: CP32 is:

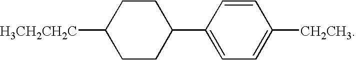

C represents a cyclohexane ring. P represents a phenyl ring. TF represents a trifluoromethyl group. E represents ethylene. In the lists and within the abbreviations and general formulas for the compounds given herein, it is to be understood that each possible compound that can be made having a given formula is individually disclosed to the same extent as if it were separately shown in the disclosure. Further, it is intended that each individual compound that can be made having a given formula can be separately included or excluded from the compositions given herein.

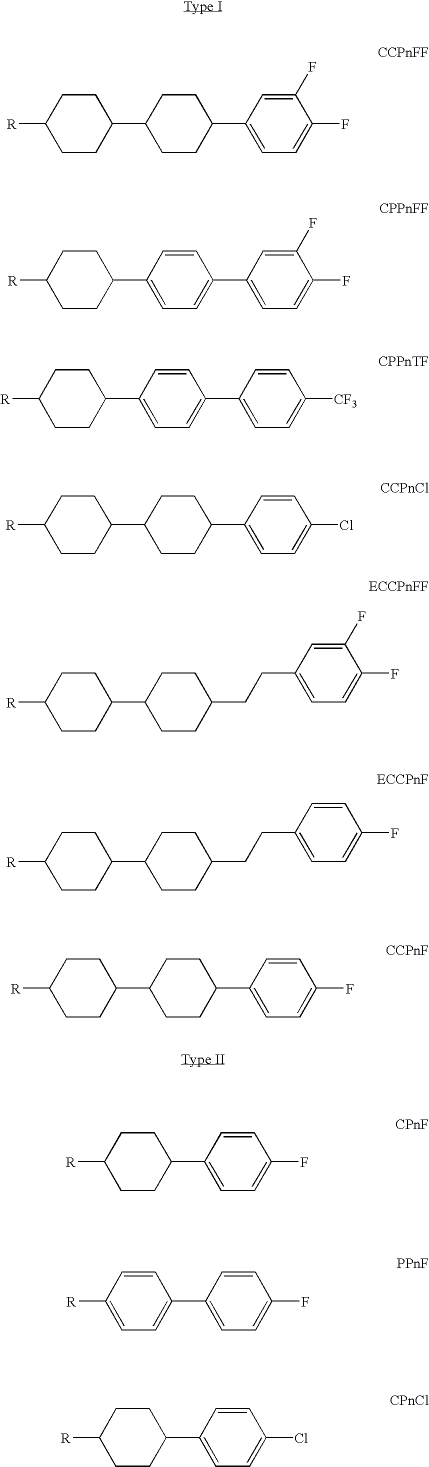

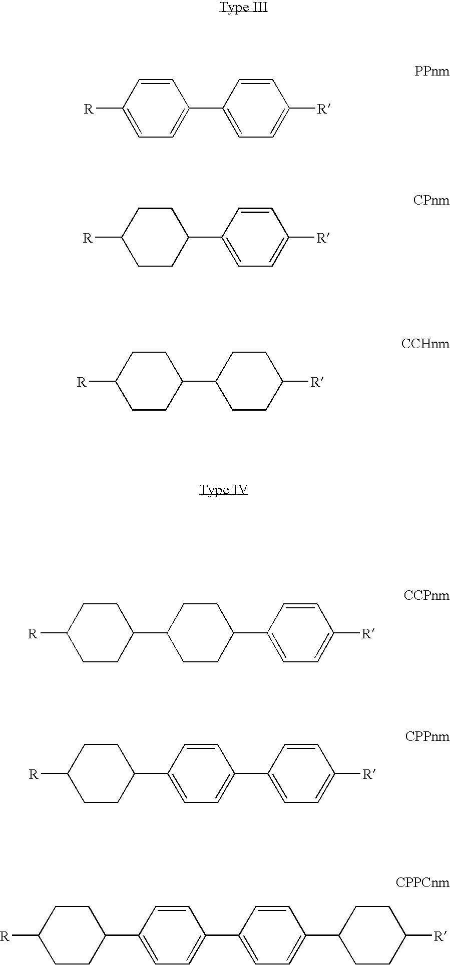

When compounds corresponding to the formula ECCPnFF are included in a composition, in one embodiment, these compounds are present in the composition in an amount less than 15%. It is preferred that the variable “Y” in the compounds of Type II is a F or Cl atom. When compounds corresponding to the formula CPPnm are included in a composition, in one embodiment, these compounds are present in the composition in an amount less than 25%. When compounds corresponding to the formula CPnF are included in a composition, in one embodiment, these compounds are present in the composition in an amount less than 25%. When compounds corresponding to the formula CCHnm are included in a composition, in one embodiment, these compounds are present in the composition in an amount less than 35%. When compounds corresponding to the formula CPnm are included in a composition, in one embodiment, these compounds are present in the composition in an amount less than 25%. When compounds corresponding to the formula CCPnF are included in a composition, in one embodiment, these compounds are present in the composition in an amount less than 40%. When compounds corresponding to the formula CCPnm are included in a composition, in one embodiment, these compounds are present in the composition in an amount less than 30%.

### Composition Examples

### Example 1

| Component | Weight Ratio | LC mixture property |
|---|---|---|
| CCP3FF | 19 | N/I: 96° C. |
| CCP5FF | 18 | Δε: 4.5 |
| CPP3FF | 15 | γ: 110 mPas |
| CPP5FF | 9 | Δn: 0.09 |
| ECCP3FF | 8 | VHR: >99% |
| ECCP5FF | 4 | |
| ECCP3F | 7 | |
| ECCP5F | 5 | |
| CP5F | 11 | |
| CCH32 | 4 | |

### Example 2

| Component | Ratio | LC mixture property |
|---|---|---|
| CCP3FF | 15 | N/I: 81° C. |
| CCP5FF | 20 | Δε: 3.8 |
| CPP3FF | 12 | γ: 85 mPas |
| CPP5FF | 16 | Δn: 0.1 |
| CCH35 | 8 | VHR: >99% |
| CCP31 | 5 | |
| PP5F | 8 | |
| CP32 | 10 | |
| CPPC33 | 2 | |
| CP5F | 4 | |

Compositions of the invention have desirable material properties including high voltage holding ratio and low viscosity. These material properties are critical for thin film transistor (TFT) LCD applications.

The material properties shown herein are defined and measured using methods known to one of ordinary skill in the art without undue experimentation. As known in the art, N/I is the transition temperature between the nematic phase and the isotropic phase. As known in the art, AE is the dielectric constant anisotropy and is the difference between the average dielectric constant measured parallel to the long axis of the molecule and the average dielectric constant measured perpendicular to the long axis of the molecule. As known in the art, γ is the rotational viscosity. As known in the art, An is the difference in the indices of refraction for the ordinary and extraordinary rays of polarized light. As known in the art, VHR is the voltage holding ratio and is a measure of the ability to retain the voltage during the time between pixel updates (frame time).

The viscosity of the mixture described herein is typically lower than 110 mPas and the VHR is typically more than 99%.

The compounds of Type I-IV are easily synthesized by methods known in the art to one or ordinary skill in the art.

When a group of substituents is disclosed herein, it is understood that all individual members of those groups and all subgroups, including any isomers and enantiomers of the group members, and classes of compounds that can be formed using the substituents are disclosed separately. When a compound is claimed, it should be understood that compounds known in the art including the compounds disclosed in the references disclosed herein are not intended to be included. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, synthetic methods, and components in the composition other than those specifically exemplified can be employed in the practice of the invention without resort to undue experimentation. All art-known functional equivalents, of any such methods, device elements, starting materials, synthetic methods, and components in the composition are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The definitions are provided to clarify their specific use in the context of the invention. All patents and publications mentioned in the specification are indicative of the levels of skill of those skilled in the art to which the invention pertains.

One skilled in the art would readily appreciate that the present invention is well adapted to carry out the objects and obtain the ends and advantages mentioned, as well as those inherent therein. The liquid crystal compounds and methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

Although the description herein contains many specificities, these should not be construed as limiting the scope of the invention, but as merely providing illustrations of some of the embodiments of the invention. Thus, additional embodiments are within the scope of the invention and within the following claims. All references cited herein are hereby incorporated by reference to the extent that there is no inconsistency with the disclosure of this specification. Some references provided herein are incorporated by reference herein to provide details concerning additional starting materials, additional methods of synthesis, additional methods of analysis and additional uses of the invention.

### REFERENCES

U.S. Pat. No. 4,822,519, issued Apr. 18, 1989
U.S. Pat. No. 5,167,860, issued Dec. 1, 1992

I claim:

1. A liquid crystal composition comprising:
10-90% by weight of one or more compounds of Type I having formula: 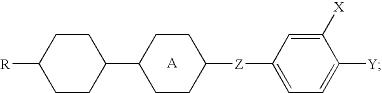
1-40% by weight of one or more compounds of Type II having formula: 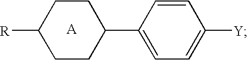
1-50% by weight of one or more compounds of Type III having formula: 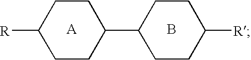
and 0-40% by weight of one or more compounds of Type IV having formula: 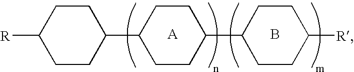
wherein in the formulas, 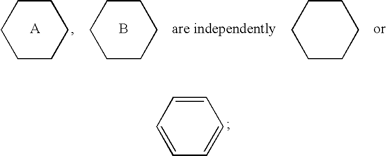
Z is a direct bond or ethylene; n=1,2; m=0,1 and n+m >1; R and R′ are optionally substituted alkyl groups with from 1-7 carbons in the chain, where the alkyl groups may be straight chain or branched, and one or more hydrogens can be replaced with one or more F or D atoms, and one or more carbon atoms can be replaced with —O—; X, Y are selected from the group consisting of: F, H, Cl and trifluoro methyl (—CF₃) groups, provided that when a compound of Type II having Y=F, R=unsubstituted alkyl group having from 1-7 carbons in the chain or alkoxymethyl group with from 2-7 carbons atoms in the chain is present in the composition, any compounds of Type I having 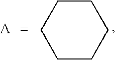
X and Y=F and Z=ethylene are present in the composition below 15% by weight or more than 80% by weight; and provided that when a compound of Type I having X=Y=F; 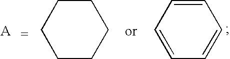
Z is a direct bond and R is an unsubstituted alkyl group with from 1-7 carbons in the chain is present in the composition, any compounds of formula (a): 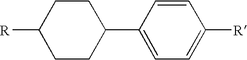
where R′ is F, or CF₃ or an unsubstituted alkyl group with from 1-7 carbons in the chain and R is an unsubstituted alkyl group with from 1-7 carbons in the chain, or compounds of formula (b): 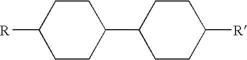
where R is R″OCH₂, where R″ is an unsubstituted alkyl group with from 1-5 carbons in the chain and R′ is an unsubstituted alkyl group with from 1-7 carbons in the chain are collectively present in the composition in an amount less than 5% by weight.

2. The liquid crystal composition of claim 1, wherein the compounds: 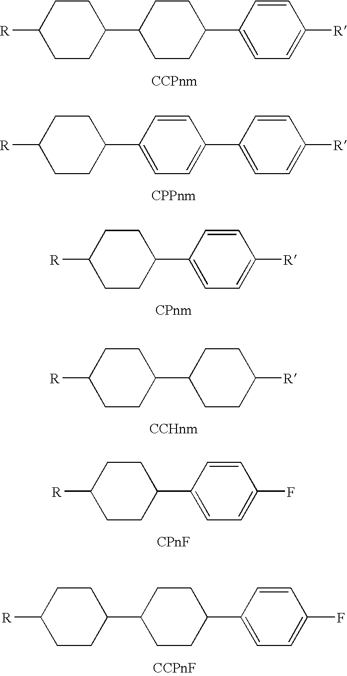
each comprise less than 5% by weight of the composition when a compound of Type I having X=Y=F, Z=direct bond and R=unsubstituted alkyl group with from 1-7 carbon atoms is present.

3. The liquid crystal composition of claim 1, wherein the one or more compounds of Type I are present in an amount of 10 to less than 15% by weight.

4. The liquid crystal composition of claim 1, wherein the one or more compounds of Type I are present in an amount above 80% by weight.

5. The liquid crystal composition of claim 1, wherein the one or more compounds of Type I are present in an amount of 10 to less than 40% by weight.

6. The liquid crystal composition of claim 1, wherein the composition contains less than 5% of compound of Type II.

7. The liquid crystal composition of claim 1, wherein the composition has the following components and percentages:

| Component | Weight Ratio |
|---|---|
| CCP3FF | 19 |
| CCP5FF | 18 |
| CPP3FF | 15 |
| CPP5FF | 9 |
| ECCP3FF | 8 |
| ECCP5FF | 4 |
| ECCP3F | 7 |
| ECCP5F | 5 |
| CP5F | 11 |
| CCH32 | 4 |

8. The liquid crystal composition of claim 1, wherein the composition has the following components and percentages:

| Component | Ratio |
|---|---|
| CCP3FF | 15 |
| CCP5FF | 20 |
| CPP3FF | 12 |
| CPP5FF | 16 |
| CCH35 | 8 |
| CCP31 | 5 |
| PP5F | 8 |
| CP32 | 10 |
| CPPC33 | 2 |
| CP5F | 4 |

9. The liquid crystal composition of claim 1, wherein the composition has a viscosity less than 110 mPas.

10. The liquid crystal composition of claim 1, wherein the compound CPnm is present in an amount less than 5%.

11. The liquid crystal composition of claim 1, wherein the compound CPnF is present in an amount less than 5%.

12. The liquid crystal composition of claim 1, wherein the compounds of Type II, III, and IV each comprise less than 10% of the composition.

13. A liquid crystal device comprising the liquid crystal composition as described in claim 1.

14. The device of claim 13, wherein the device is a display element.
